(19) United States
(12) Patent Application Publication
(10) Pub. No.: US 2023/0385366 A1
(43) Pub. Date: Nov. 30, 2023

(54) METHOD FOR ECOLOGICAL DISTURBANCE RISK IDENTIFICATION AND ASSESSMENT BASED ON AUTOMATIC PARAMETER ADJUSTING OPTIMIZATION MODEL

(71) Applicant: SATELLITE APPLICATION CENTER FOR ECOLOGY ENVIRONMENT, MEE, BEIJING (CN)

(72) Inventors: Jixi Gao, Beijing (CN); Mingyong Cai, Beijing (CN); Xinsheng Zhang, Beijing (CN); Wenfei Tai, Beijing (CN); Xuhui Chen, Beijing (CN); Yuanli Shi, Beijing (CN); Zhen Shen, Beijing (CN); Tong Xiao, Beijing (CN); Wandong Ma, Beijing (CN); Jianxin Sun, Beijing (CN); Xue Zhang, Beijing (CN); Zhihua Ren, Beijing (CN)

(21) Appl. No.: 17/871,969

(22) Filed: Jul. 24, 2022

(30) Foreign Application Priority Data
May 27, 2022 (CN) 2022105942013

(51) Int. Cl. G06F 17/17

(52) U.S. Cl. CPC G06F 17/17

(57) ABSTRACT

A method for ecological disturbance risk identification and assessment based on automatic parameter adjusting optimization model is disclosed. The method includes: establishing a three-layer ecological disturbance risk assessment index system based on an ecological disturbance risk identification and assessment function, performing normalization preprocessing on the assessment indexes, screening the assessment indexes meeting a multicollinearity judgement interval based on variance inflation factor method, establishing an ecological disturbance risk assessment model, optimizing weight parameters of the ecological disturbance risk assessment model based on particle swarm optimization algorithm to obtain an optimal solution of the model weight, and outputting a result of the risk index of ecological disturbance. The disclosure realizes the optimization of the index weight parameters and the optimization of the assessment indexes of the ecological interference risk identification and assessment model, and ensures the accuracy of the ecological disturbance risk identification and assessment model and the assessment results.

### CROSS REFERENCE TO RELATED APPLICATION

This patent application claims the benefit and priority of Chinese Patent Application No. 202210594201.3 filed on May 27, 2022, the disclosure of which is incorporated by reference herein in its entirety as part of the present application.

### TECHNICAL FIELD

The present disclosure relates to the technical field of ecological risk analysis, and more specifically, to a method for ecological disturbance risk identification and assessment based on automatic parameter adjusting optimization model.

### BACKGROUND ART

Protecting the ecological environment, preventing ecological risks and ensuring ecological security have become an important part of national security. With the strengthening of the research on global environmental change and sustainable development, as well as the deepening of people's understanding of the development concept of ecological civilization, the problem of ecological environment disturbance risk has been paid more and more attention. Ecological disturbance risk refers to the possibility and degree of ecological damage caused by natural or human factors. It is a comprehensive reflection of the characteristics of ecosystems at different scales, various natural environmental background conditions and the direct and potential impacts of human disturbance activities. At present, the existing researches on ecological disturbance risk identification around the world are mainly to assess the ecological risk of the basin or area. For example, Wei Fu and others took the Loess Plateau in Northern Shaanxi, which is ecologically fragile and sensitive to the interaction between people and the ecological environment, as a typical research object to establish a landscape ecological risk index to identify and assess the comprehensive risk status and changes of the Loess Plateau in Northern Shaanxi. Li et al. carried out ecological risk assessment of chromophoric dissolved organic matter (CDOM) in Yinma River Basin from three aspects: ecological sensitivity, ecological pressure and self resilience. Taking Jixi County in Anhui Province as a case, XiaoRui Zhang and others constructed a comprehensive assessment model of county ecological risk based on “sensitivity-disturbance degree”. Most of the risk identification steps of the research content can be summarized as the construction of risk assessment conceptual model/mathematical model, the selection of assessment indexes, the assignment of index weights, the analysis of ecological risk assessment and so on.

At present, most of the researches focus on the application of ecological disturbance risk area assessment model, and there is still a lack of research breakthrough in the optimization of risk identification model parameters and the selection of assessment indexes. It is mainly reflected in the following two aspects:

First, the process of ecological disturbance risk identification and assessment involves the assignment of the weights of assessment indexes. The existing research basically uses subjective weighting methods such as expert scoring or analytic hierarchy process to determine the weights of assessment indexes. However, the weighting process of these methods excessively relies on the subjective determination of professional background and knowledge experience. The results obtained by different assessment subjects are different, which leads to the fact that the weights of assessment indexes can not truly and objectively reflect the actual contribution of each index.

Second, in the construction of the technical system of ecological disturbance risk identification, the selection of assessment indexes also directly affects the results of ecological disturbance risk identification. The traditional index selection method does not take into account the possible high correlation among the indexes, resulting in multicollinearity in the index quality inspection of the assessment model, which leads to over fitting of the linear regression equation and affects the authenticity of the risk identification model.

Therefore, it is an urgent problem for those skilled in the art to provide an ecological disturbance risk identification and assessment method that can realize the optimization of the index weight parameters of the ecological disturbance risk identification and assessment model and the selection of the assessment indexes.

### SUMMARY

In view of the above, the disclosure realizes the optimization of the index weight parameters of the ecological disturbance risk identification and assessment model and the selection of the assessment indexes by introducing the particle swarm parameter intelligent optimization algorithm and the VIF multicollinearity detection, and ensures the accuracy of the ecological disturbance risk identification and assessment model and the assessment results.

In order to achieve the above purpose, technical solutions of the present disclosure are specifically described as follows.

The disclosure provides a method for ecological disturbance risk identification and assessment based on automatic parameter adjusting optimization model, including the following steps.

S1. establishing a three-layer ecological disturbance risk assessment index system based on an ecological disturbance risk identification and assessment function. A target layer is a risk index of ecological disturbance, a criterion layer is a sub risk index of ecological disturbance, and an index layer is assessment indexes of each sub risk index of ecological disturbance.

S2. performing normalization preprocessing on the assessment indexes.

S3. calculating a multicollinearity among the indexes in combination with a linear regression model of each assessment index based on variance inflation factor method, and screening the assessment indexes meeting a multicollinearity judgement interval.

S4. establishing an ecological disturbance risk assessment model according to the ecological disturbance risk assessment index system and the assessment indexes after normalization preprocessing and the multicollinearity judgement. A model weight of the ecological disturbance risk assessment model includes a criterion layer index weight and an index layer index weight.

S5. optimizing weight parameters of the ecological disturbance risk assessment model based on particle swarm optimization algorithm to obtain an optimal solution of the model weight.

S6. substituting the optimal solution of the model weight into the ecological disturbance risk identification and assessment model for calculation, and outputting a result of the risk index of ecological disturbance.

Preferably, the ecological disturbance risk identification and assessment function is the function of the risk index of ecological disturbance PIED on the sub risk indexes of ecological disturbance, and the sub risk indexes of ecological disturbance include ecology vulnerability EV, accessibility to interference AI and resource easy-attractiveness RE.

Preferably, an assessment area is divided into grids, and the sub risk indexes of ecological disturbance are calculated with the grids as assessment units.

Preferably, the S2 includes the following steps.

S21. performing a preprocessing operation on the assessment area to make data range, format and spatial resolution of the assessment indexes consistent. The preprocessing operation includes clipping, rasterizing, coordinate system conversion and resampling.

S22. normalizing the assessment indexes by range standardization method.

Preferably, the S22 includes: normalizing the quantitative assessment indexes by range standardization method; quantifying the qualitative assessment indexes first by expert grading assignment method, and then normalizing by range standardization method, so that the range of each assessment index is between 0 and 1.

Preferably, the linear regression model in S3 is that each independent variable of the assessment indexes is a linear regression function with respect to other independent variables of the assessment indexes.

Preferably, the calculating a multicollinearity VIF among the indexes and screening the assessment indexes meeting a multicollinearity judgement interval in the S3 includes:

$${VIF}_{i} = \frac{1}{1 - {R}_{i}^{2}}$$

$${R}_{i}^{2} = \frac{\sum {( {\hat{x}}_{i} - \overline{{x}_{i}} )}^{2}}{\sum {( {x}_{i} - \overline{{x}_{i}} )}^{2}}$$

Where, \hat{x}ᵢ is a result of the i-th assessment index obtained by fitting the model, xᵢ is an actual result of the i-th index, and x̅ᵢ is an average of the actual results of the i-th index; and

screening the assessment indexes meeting VIFᵢ<S to participate in the calculation of the ecological disturbance risk identification and assessment model. S is a multicollinearity judgement boundary.

Preferably, the ecological disturbance risk identification and assessment model is built as follows:

RIED=W_{EV}·A_{EV}+W_{AI}·A_{AI}+W_{RE}·A_{RE}

A_{EV}=W_{α1}·α1+W_{α2}·α2+ . . . +W_{αi}·αi

A_{AI}=W_{β1}·β1+W_{β2}·β2+ . . . +W_{βj}·βj

A_{RE}=W_{γ1}·γ1+W_{γ2}·γ2+ . . . +W_{γk}·γk

Where, RIED is the risk index of ecological disturbance, with a range of [0,1] to indicate a possibility and damage degree of the regional ecosystem affected by natural factors or human activities. A_{EV}, A_{AI} and A_{RE} are ecology vulnerability index, accessibility to interference index and resource easy-attractiveness index respectively. W_{EV}, W_{AI} and W_{RE} are weight values of ecology vulnerability index, accessibility to interference index and resource easy-attractiveness index respectively. W_{αi} and αi are weights of specific indexes included in ecological vulnerability and standard values after the normalized pretreatment. W_{βj} and βj are weights of specific indexes included in accessibility to interference and standard values after normalized pretreatment. W_{γk} and γk are weights of specific indexes included in resource easy-attractiveness and standard values after the normalized pretreatment. And i+j+k=p.

Preferably, the S5 includes the following steps.

S51. establishing a weight parameter optimization objective function:

minF=Σₐ₌₁^{N}(REIDₐ−VALUEₐ)

W_{EV}+W_{AI}+W_{RE}=1

W_{α1}+W_{α2}+ . . . +W_{αi}=1

W_{β1}+W_{β2}+ . . . +W_{βj}=1

W_{γ1}+W_{γ2}+ . . . +W_{γk}=1

i+j+k=p

Wherein, N is the total number of grids in the assessment area. RIEDₐ is an risk index of ecological disturbance of each grid calculated by the assessment model. VALUEₐ is a risk value of human disturbance activities for each grid. p is the total number of the assessment indexes involved in the calculation of ecological disturbance risk identification and assessment. i, j and k are the number of the assessment indexes included in ecology vulnerability, accessibility to interference and resource easy-attractiveness respectively.

S52. calculating individual fitness of the assessment indexes according to the weight parameter optimization objective function.

S53. calculating individual extreme values and global extreme values of the assessment indexes by the particle swarm optimization algorithm, updating particles, calculating the individual fitness of S52 again, and executing S53 circularly until termination conditions are met.

S54. outputting a swarm optimal value as a model weight optimal solution according to the weight parameter optimization objective function.

Preferably, the S6 includes grading, mapping and displaying visually the assessment results of the risk index of ecological disturbance, and/or grading, mapping and displaying visually the assessment results of each sub risk index of ecological disturbance.

According to the above technical scheme, compared with the prior art, the disclosure has the following beneficial effects.

The disclosure defines an ecological disturbance risk identification and assessment method based on an automatic parameter adjusting optimization model, including six parts: establishment of ecological disturbance risk identification and assessment function and index system, pretreatment of risk identification and assessment indexes, selection of risk identification and assessment indexes, determination of ecological disturbance risk assessment model, optimization of weight parameters of ecological disturbance risk identification and assessment model, and output of ecological disturbance risk identification and assessment results.

Aiming at the problem of risk assessment index weight assignment, the disclosure creatively proposes a weight parameter optimization technical method based on particle swarm optimization algorithm. By constructing the parameter optimization objective function, the automatic parameter adjusting optimization of the index weights of the ecological disturbance risk identification and assessment model is realized, which avoids the subjectivity and randomness of the artificial weight assignment.

When screening the indexes in the ecological disturbance risk identification and assessment, the disclosure incorporates the VIF Multicollinearity detection method, realizes the selection of the ecological disturbance risk identification and assessment indexes, and ensures the scientificity and rationality of the risk identification and assessment indexes.

Assessment index selection and index weight assignment are the two most important links in the process of ecological disturbance risk identification and assessment. Based on this, the disclosure has the following two advantages.

1. By constructing the parameter optimization objective function, the disclosure creatively proposes the index weight parameter optimization technical method of ecological disturbance risk identification and assessment based on particle swarm optimization algorithm, realizes the parameter self-optimization ability of index weights, and solves the problem that the weights obtained in the traditional weighting process can not truly and objectively reflect the actual contribution of each index due to the difference of personal knowledge and experience.

2. In order to solve the problem of over fitting the model due to the high correlation between the assessment indexes, when selecting the ecological disturbance risk identification and assessment indexes, the present disclosure constructs a regression model among the indexes for VIF multicollinearity detection, ensures the independence, scientificity and rationality of the ecological disturbance risk identification and assessment indexes, and realizes the optimization of the ecological disturbance risk identification and assessment indexes.

### BRIEF DESCRIPTION OF THE DRAWINGS

In order to explain the embodiments of the present disclosure or the technical solutions in the prior art more clearly, the following drawings that need to be used in the description of the embodiments or the prior art will be briefly introduced. Obviously, the drawings in the following description are only embodiments of the present disclosure. For those of ordinary skill in the art, other drawings can be obtained based on the drawings disclosed without creative work.

FIG. 1 is the flow chart of the method for ecological disturbance risk identification and assessment based on automatic parameter adjusting optimization model provided by the embodiments of the disclosure.

FIG. 2 is the architecture diagram of the ecological disturbance risk assessment index system provided by the embodiments of the disclosure.

FIG. 3 is the architecture diagram of the ecological vulnerability assessment index layer provided by the embodiments of the disclosure.

FIG. 4 is the architecture diagram of the accessibility to interference assessment index layer provided by the embodiment of the disclosure.

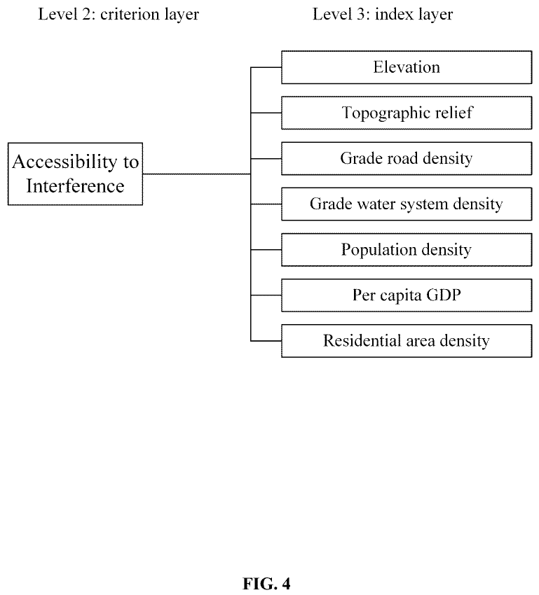

FIG. 5 is the architecture diagram of the resource easy-attractiveness assessment index layer provided by the embodiment of the disclosure.

FIG. 6 is the positive correlation index normalization batch processing flow provided by the embodiments of the disclosure.

FIG. 7 is the negative correlation index normalization batch processing flow provided by the embodiments of the disclosure.

FIG. 8 is the flow chart of weight parameter optimization of the ecological disturbance risk identification and assessment model provided by the embodiments of the disclosure.

FIG. 9 is the flow chart of weight optimization based on particle swarm optimization algorithm provided by the embodiments of the disclosure.

FIG. 10 is the ecological vulnerability index level map provided by the embodiments of the disclosure.

FIG. 11 is the accessibility to interference index level map provided by the embodiments of the disclosure.

FIG. 12 is the resource easy-attractiveness index level map of the provided by the embodiments of the present disclosure.

FIG. 13 is a thematic map of ecological disturbance risk level provided by the embodiments of the present disclosure.

### DETAILED DESCRIPTION OF THE EMBODIMENTS

Technical solutions of the present disclosure will be clearly and completely described below with reference to drawings in the embodiments. Obviously, the described embodiments are only part of the embodiments of the present disclosure, not all of them. Based on the embodiments of the disclosure, all other embodiments obtained by those skilled in the art without making creative work belong to the protection scope of the disclosure.

The embodiment of the disclosure provides an ecological disturbance risk identification and assessment method based on the automatic parameter adjusting optimization model, including the establishment of the assessment function and index system, the determination of the assessment model, the assignment of the assessment index weight parameters, the hierarchical application of the risk identification results, etc. Among them, the selection of model indexes and the assignment of weight parameters are the two most important links. The selection of reasonable and representative indexes is the basis for accurate risk identification and assessment results.

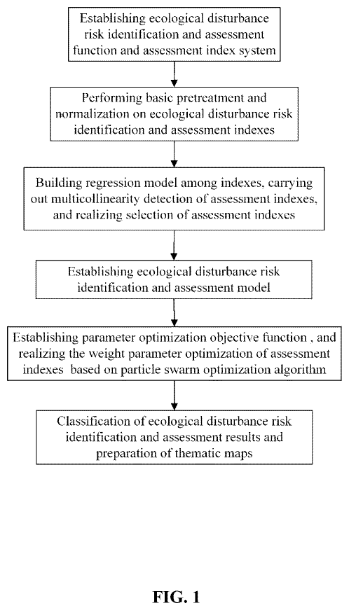

Referring to FIG. 1, the method includes the following steps.

S1. establishing a three-layer ecological disturbance risk assessment index system based on an ecological disturbance risk identification and assessment function. A target layer is a risk index of ecological disturbance, a criterion layer is a sub risk index of ecological disturbance, and an index layer is assessment indexes of each sub risk index of ecological disturbance.

The specific implementation process is as follows.

In one embodiment, S11 includes establishing an ecological disturbance risk identification and assessment function.

The ecological disturbance risk is the result of the comprehensive action of natural environment, human activities and resource endowment. The ecological disturbance risk assessment should first assess the vulnerability of the regional ecosystem due to its own characteristics (ecosystem composition, quality, etc.), material basic conditions (topography, soil foundation, etc.) and environmental impact (ecological space type, temperature, precipitation, etc.), that is, “ecological vulnerability”. Ecological vulnerability is a comprehensive reflection of the vulnerability and sensitivity of the ecosystem itself and the elasticity of the ecosystem. Population distribution and road traffic conditions determine the difficulty degree to which the ecological space is vulnerable to various human activities and thus ecological damage. Therefore, on the basis of considering the vulnerability of the ecosystem itself, the ecological disturbance risk assessment must pay attention to the impact of “accessibility to interference” caused by population and traffic. At the same time, the potential risks of illegal exploitation, poaching and large-scale tourism development which may be induced due to the existence of various natural resources in the region, i.e. “resource easy-attractiveness” are also taken into account in the ecological disturbance risk assessment. Based on this, the ecological disturbance risk identification and assessment function can be defined as:

RIED=F(ecological vulnerability, accessibility to interference, resource easy-attractiveness)=f(EV, AI, RE)

Where, RIED is the risk index of ecological disturbance, EV is the ecology vulnerability, AI is the accessibility to interference and RE is the resource easy-attractiveness.

S12. establishing the ecological disturbance risk index system.

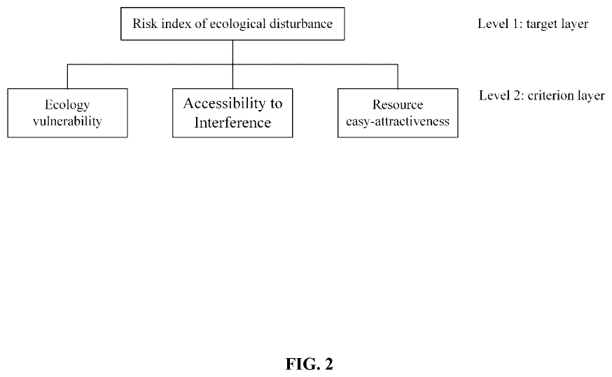

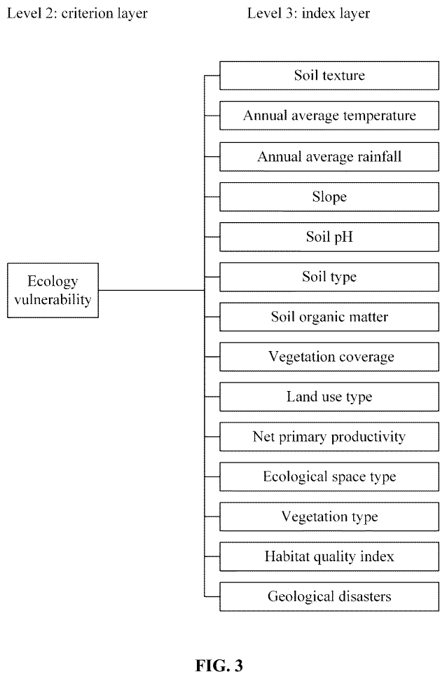

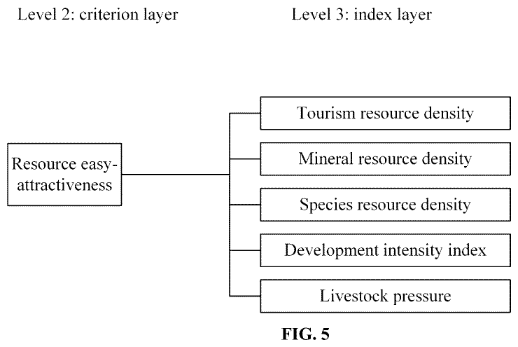

This embodiment adopts a top-down approach to build a three-layer ecological disturbance risk assessment index system, as shown in FIG. 2. The first layer is the target layer, that is, the risk index of ecological disturbance, which comprehensively reflects the possibility and damage degree of the regional ecosystem affected by natural factors or human activities. The second layer is the criterion layer, which measures the risk of ecological disturbance from three aspects: ecological environment, human activities and resource endowment. The third layer is the index layer, including the specific indexes required for the assessment of each criterion layer. FIG. 3 FIG. 5 are the index layer architectures required for the assessment of “EV, AI, RE”.

During the assessment, the lower level indexes calculate the upper level indexes. The calculation can be carried out on the basis of grid assessment units, that is, the assessment area is divided into grids, and the risk index calculation is carried out for each assessment unit in terms of ecological vulnerability, accessibility to interference and resource easy-attractiveness. In order to improve the of the ecological disturbance risk identification and assessment and refine the calculation, the disclosure adopts a grid size of 100 m×100 m spatial refinement scale.

S2. performing normalization preprocessing on the assessment indexes.

The specific implementation process is as follows.

In one embodiment, S21 includes the basic pretreatment processing.

For all risk identification and assessment indexes, the assessment area clipping, rasterizing, coordinate system conversion, resampling and other processing operations shall be carried out to ensure that the data range, format and spatial resolution of all indexes are consistent.

In one embodiment, S22 includes the normalization process.

Due to the different physical meanings and dimensions represented by each index, it is impossible to directly participate in the assessment calculation. In order to eliminate the difference of index dimension and order of magnitude and make the indexes comparable, it is necessary to standardize each assessment index. The commonly used standardization methods include range standardization and standard deviation standardization. In the disclosure, the quantitative index adopts range standardization, and the qualitative index is first quantified by expert grading assignment method, and then is normalized by range standardization, so that the value range of each index is between 0 and 1.

Among them, the number of grades by the expert grading assignment method is consistent with the number of proposed levels of the final ecological disturbance risk identification and assessment results, and the indexes after grading are positive indexes. For example, in the embodiment of the disclosure, the risk identification and assessment results are divided into five levels, so the qualitative indexes are also divided into five levels, as shown in Table 1.

TABLE 1
Expert grading assignment of qualitative indexes

| | Standardized assignment | | | | |
|---|---|---|---|---|---|
| Index | 1 | 2 | 3 | 4 | 5 |

Qualitative index 1
Qualitative index 2
Qualitative index 3
. . .

Range standardization method: the relationship between assessment indexes and ecological disturbance risk can be divided into positive and negative directions, and different standardized calculation formulas are required. The positive relationship is that the greater the assessment index value, the higher the ecological disturbance risk. The negative relationship is that the greater the assessment index value, the smaller the ecological disturbance risk.

### Positive Relationship

$${Z}_{i} = \frac{{x}_{i} - {x}_{min}}{{x}_{max} - {x}_{min}}$$

### Negative Relationship

$${Z}_{i} = \frac{{x}_{max} - {x}_{i}}{{x}_{max} - {x}_{min}}$$

Where, Zᵢ is the standardized value of the i-th index, of which the range is 0-1, xᵢ is the actual value of the i-th indicator, xₘₐₓ is the maximum value of the actual value of the i-th index, xₘᵢₙ is the minimum value of the actual value of the i-th index.

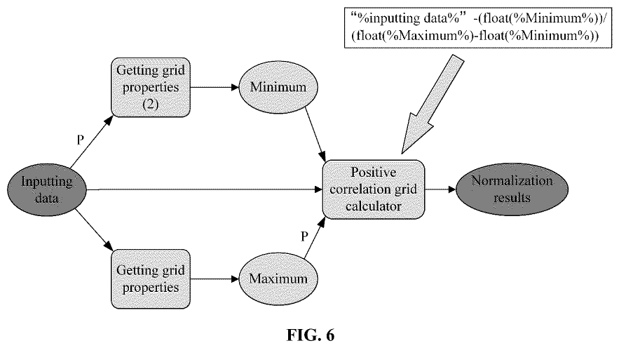

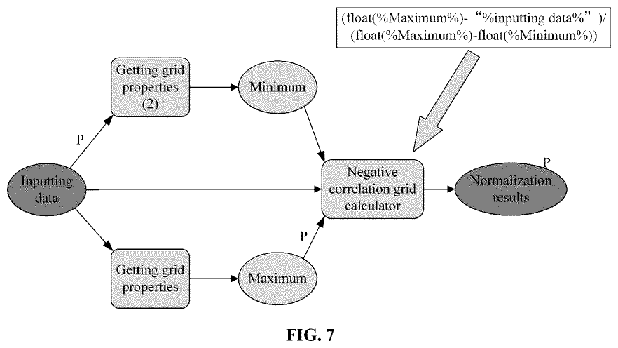

When normalizing the multiple assessment indexes, in order to improve the efficiency of index preprocessing, a batch process is built with the help of the model builder tool in arcGIS, as shown in FIG. 6 and FIG. 7.

S3. calculating a multicollinearity among the indexes in combination with a linear regression model of each assessment index based on variance inflation factor method, and screening the assessment indexes meeting a multicollinearity judgement interval.

Based on the preprocessed index data, the selection ecological disturbance risk identification and assessment indexes is carried out. The selection of the identification and assessment indexes is to screen out independent variables that are independent of each other and participate in the final ecological disturbance risk identification and assessment model calculation through the multicollinearity detection among the assessment indexes. Multicollinearity means that there is a linear correlation between independent variables, that is, an independent variable can be a linear combination of one or several other independent variables. Although multicollinearity does not affect the performance of the model, it affects the interpretability of the model. The actual contribution rate of a variable to the result can be obtained by removing the multicollinearity.

The specific implementation process is as follows.

In one embodiment, S31 includes constructing a linear regression model.

The linear regression model of each independent variable and remaining independent variables is constructed in turn, as follows:

$${x}_{1} = {b}_{1} + {a}_{2} {x}_{2} + {a}_{3} {x}_{3} + … + {a}_{n} {x}_{n} + {ε}_{1}$$

$${x}_{2} = {b}_{2} + {a}_{1} {x}_{1} + {a}_{3} {x}_{3} + … + {a}_{n} {x}_{n} + {ε}_{2}$$

$$…$$

$${x}_{i} = {b}_{i} + {a}_{1} {x}_{1} + … + {a}_{i - 1} {x}_{i - 1} + {a}_{i + 1} {x}_{i + 1} + … + {a}_{n} {x}_{n} + {ε}_{i}$$

$$…$$

$${x}_{n} = {b}_{n} + {a}_{1} {x}_{1} + {a}_{2} {x}_{2} + … + {a}_{n - 1} {x}_{n - 1} + {ε}_{n}$$

Where, n is the number of indexes involved in ecological disturbance risk identification and assessment.

In one embodiment, S32 includes a multicollinearity judgement.

In this embodiment, the variance inflation factor (VIF) is used to judge the multicollinearity between the assessment indexes. VIF refers to the ratio of variance when there is multicollinearity between independent variables to variance when there is no multicollinearity. The value of VIF is greater than 1. The closer the value of VIF is to 1, the lighter the multicollinearity is, and vice versa. Generally, 10 is taken as the judgment boundary. When VIF<10, there is no multicollinearity.

$${VIF}_{i} = \frac{1}{1 - {R}_{i}^{2}}$$

$${R}_{i}^{2} = \frac{\sum {( {\hat{x}}_{i} - \overline{{x}_{i}} )}^{2}}{\sum {( {x}_{i} - \overline{{x}_{i}} )}^{2}}$$

Where, \hat{x}ᵢ is a result of the i-th assessment index obtained by fitting the model, xᵢ is an actual result of the i-th index, and x̅ᵢ is an average of the actual results of the i-th index.

The coefficient aᵢ in the linear regression model represents the contribution rate of its corresponding variable, which is obtained by solving the equation with the actual values of multiple sets of independent variables, and bᵢ and εᵢ are simultaneously obtained by solving the equation. The better the model fitting effect, the closer Rᵢ² is to 1, and the greater the possibility of multicollinearity between independent variables.

Based on this, p (p≤n) indexes involved in the calculation of the ecological disturbance risk identification and assessment model are screened out.

S4. establishing an ecological disturbance risk assessment model according to the ecological disturbance risk assessment index system and the assessment indexes after normalization preprocessing and the multicollinearity judgement. A model weight of the ecological disturbance risk assessment model includes a criterion layer index weight and an index layer index weight.

In one embodiment, the ecological disturbance risk is the result of the combined effect of three aspects: ecological vulnerability, accessibility to interference, and resource easy-attractiveness. According to the ecological disturbance risk identification and assessment function framework, the ecological disturbance risk identification and assessment model is constructed as follows:

RIED=W_{EV}·A_{EV}+W_{AI}·A_{AI}+W_{RE}·A_{RE}

A_{EV}=W_{α1}·α1+W_{α2}·α2+ . . . +W_{αi}·αi

A_{AI}=W_{β1}·β1+W_{β2}·β2+ . . . +W_{βj}·βj

A_{RE}=W_{γ1}·γ1+W_{γ2}·γ2+ . . . +W_{γk}·γk

Where, RIED is the risk index of ecological disturbance, with a range of [0,1] to indicate a possibility and damage degree of the regional ecosystem affected by natural factors or human activities, and the larger the value of RIED, the greater the possibility and degree of damage to the ecological environment. A_{EV}, A_{AI} and A_{RE} are ecology vulnerability index, accessibility to interference index and resource easy-attractiveness index respectively. W_{EV}, W_{AI} and W_{RE} are weight values of ecology vulnerability index, accessibility to interference index and resource easy-attractiveness index respectively, which are obtained by particle swarm optimization algorithm, and are the sum of the weights of each assessment index multiplied by the weight normalization coefficient of the corresponding criterion layer. W_{αi} and αi are weights of specific indexes included in ecological vulnerability and standard values after the normalized pretreatment. W_{βj} and βj are weights of specific indexes included in accessibility to interference and standard values after normalized pretreatment. W_{γk} and γk are weights of specific indexes included in resource easy-attractiveness and standard values after the normalized pretreatment. And i+j+k=p.

S5. optimizing weight parameters of the ecological disturbance risk assessment model based on particle swarm optimization algorithm to obtain an optimal solution of the model weight.

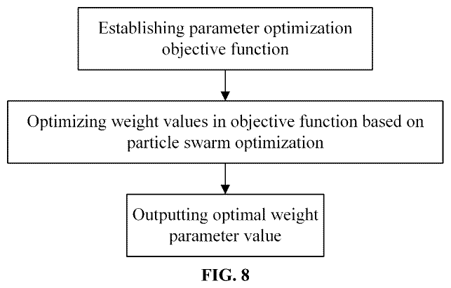

According to the ecological disturbance risk identification and assessment model, the assessment indexes and index weights are two key factors affecting the assessment results. Through the index selection in the third step, the rationality and scientificity of the index selection of the assessment model calculation can be realized. On the other hand, the scientific assignment of index weights in the assessment model is also intuitive and important. The disclosure proposes a method for optimizing weight parameters based on particle swarm optimization algorithm, as shown in FIG. 8. The specific implementation process is as follows:

S51. establishing the weight parameter optimization objective function

As a kind of evolutionary algorithm, particle swarm optimization (PSO) optimizes and models the index weights in ecological disturbance risk identification and assessment when dealing with parameter optimization problems. The following minimization objective functions can be established:

minF=Σₐ₌₁^{N}(REIDₐ−VALUEₐ)

W_{EV}+W_{AI}+W_{RE}=1

W_{α1}+W_{α2}+ . . . +W_{αi}=1

W_{β1}+W_{β2}+ . . . +W_{βj}=1

W_{γ1}+W_{γ2}+ . . . +W_{γk}=1

i+j+k=p

Where, N is the total number of grids in the assessment area, and the 100 m×100 m spatial refinement scale is adopted. RIEDₐ is the risk index of ecological disturbance of each grid calculated by the assessment model. VALUEₐ is the risk value of human disturbance activities for each grid, which is obtained based on the general investigation data of geographical conditions. p is the total number of the assessment indexes involved in the calculation of ecological disturbance risk identification and assessment. i, j and k are the number of the assessment indexes included in ecology vulnerability, accessibility to interference and resource easy-attractiveness respectively. When the constraint conditions in the formula are satisfied and the minimum value is obtained, the weight parameters of each index obtained are the optimal weight parameters.

S52. optimization of weight parameters based on particle swarm optimization Particle swarm optimization (PSO) simulates the predation behavior of birds by observing the behavior of birds in groups, and each particle is a solution in the solution space. PSO is initialized as a group of random particles (random solutions), and then the optimal solution is found through iteration. In a D-dimensional search space, the position of the i-th particle is Xᵢ=(Xᵢ₁, Xᵢ₂, . . . , X_{iD}) and the velocity is Vᵢ=(Vᵢ₁, Vᵢ₂, . . . , V_{iD}). In each iteration, each particle adjusts its flight according to the two “extreme values” generated by its own flight experience and the flight experience of its companions. One is that the optimal solution found by the particle itself is called the individual extreme value pbest, and the other is that the optimal solution found by the whole swarm is called the global extreme value gbest. In practice, the “good or bad” degree of particles is assessed by the objective function determined by the optimization problem. When the two optimal solutions are found, the particle itself is updated by the following formula.

v_{id}^{k+1}=v_{id}^{k}+c1rand1^{k}(pbest_{id}^{k}−x_{id}^{k})+c2rand2^{k}(gbest_{d}^{k}−x_{id}^{k})

x_{id}^{k+1}=x_{id}^{k}+v_{id}^{k+1}

Where, v_{id}^{k} is the velocity of particle i in the d-th dimension in the k-th iteration. x_{id}^{k} is the current position of particle i in the d-th dimension in the k-th iteration. pbest_{id} is the position of individual extreme point of particle i in the d-th dimension in the k-th iteration. gbest_{d} is the position of the global extreme value of the whole swarm in the d-th dimension. c1 and c2 are learning factors. rand1 and rand2 are random numbers between 0 and 1.

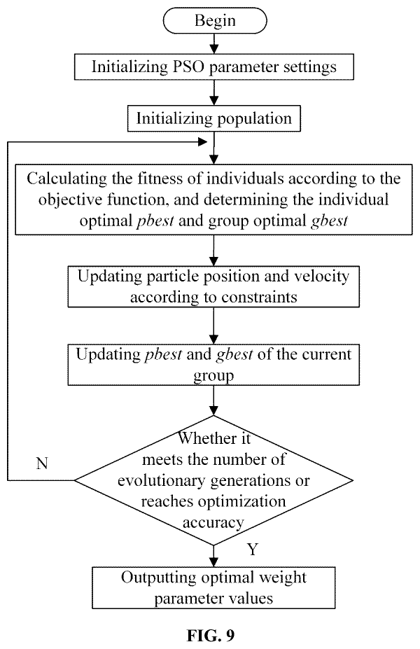

As shown in FIG. 9, the process steps of weight optimization based on particle swarm optimization algorithm are as follows.

Step 1: initializing the learning factors c1=c2=2 in the particle swarm optimization algorithm, wherein the search space dimension D=p, and the number of iterations Z=500.

Step 2: initializing 100 individuals, and then randomly generating the position and speed of each individual.

Step 3: substituting the specific index data and randomly generated swarm data included in the ecological vulnerability, accessibility to interference and resource resource easy-attractiveness involved in the model calculation into the objective function for calculation.

Step 4: determining the individual optimal value pbest and the group optimal value gbest.

Step 5: comparing the current position of the particle with the best position pbest it has experienced, taking the current best position of the particle as the particle pbest if the current position of the particle is better than pbest, otherwise, keeping the optimal position of pbest unchanged.

Step 6: comparing the current position of the particle with the optimal position gbest experienced by the group, taking the current optimal position of the particle as the particle gbest if the current position of the particle is better than gbest, otherwise, keeping the gbest optimal position unchanged.

Step 7: judging whether the termination conditions are met, outputting the group optimal value if the termination conditions are met, otherwise, updating the speed and position of the particles and returning to Step3 to bring new particles into the objective function for calculation.

Step8: outputting the last generation of swarm that meets the termination conditions, and selecting the value of the optimal individual as the optimal solution for the optimization of weight parameters of ecological disturbance risk identification and assessment.

S6. substituting the optimal solution of the model weight into the ecological disturbance risk identification and assessment model for calculation, and outputting a result of the risk index of ecological disturbance.

In one embodiment, the index weight parameters optimized based on the particle swarm optimization algorithm are substituted into the ecological disturbance risk identification and assessment model for calculation, the result of the risk index of ecological disturbance is output, and the assessment results are graded and visually displayed. The ecological disturbance risk can be divided into five levels: lowest risk area, lower risk area, medium risk area, higher risk area and highest risk area.

If RIED∈[0, S₁), the study area is a lowest risk area of ecological disturbance.

If RIED∈[S₁, S₂), the study area is a lower risk area of ecological disturbance.

If RIED∈[S₂, S₃), the study area is a medium risk area of ecological disturbance.

If RIED∈[S₃, S₄), the study area is a higher risk area of ecological disturbance.

If RIED∈[S₄, 1], the study area is a highest risk area of ecological disturbance.

Where, S₁, S₂, S₃ and S₄ are the thresholds of level division, which can be comprehensively determined according to the natural breakpoint method and historical experience value.

Finally, with the help of visual mapping software, ecological vulnerability index map, accessibility to interference index map, resource easy-attractiveness index map and ecological disturbance risk level thematic map are drawn.

The following is an analysis case of ecological disturbance risk identification and assessment in the specific assessment area.

In this case, the Qinling region of Shaanxi Province was taken as an example to carry out the application of ecological disturbance risk identification and assessment technology based on automatic parameter adjusting optimization model. Through the introduction of particle swarm optimization algorithm and VIF multicollinearity detection, the optimization of index weight parameters and the optimization of assessment indexes of ecological disturbance risk identification and assessment model were realized.

S1. The three-layer ecological disturbance risk assessment index system was established based on the ecological disturbance risk identification and assessment function.

S11. The ecological disturbance risk identification and assessment function was established.

The ecological disturbance risk identification and assessment model of “ecological vulnerability-accessibility to interference-resource easy-attractiveness” was studied and built, and the risk index of ecological disturbance (RIED) was put forward, which comprehensively reflects the possibility and damage degree of the regional ecosystem vulnerable to natural factors or human activities. The model was as follows:

RIED=F(ecological vulnerability, accessibility to interference, resource easy-attractiveness)=f(EV, AI, RE)

S12. The ecological disturbance risk index system was established.

The three-layer ecological disturbance risk assessment index system of “target layer-criterion layer-index layer” in Qinling region was built. The first layer was the target layer, that is, the risk index of ecological disturbance, which comprehensively reflects the possibility and damage degree of the regional ecosystem affected by natural factors or human activities. The second layer was the criterion layer, which measures the risk of ecological disturbance from three aspects: ecological environment, human activities and resource endowment. The third layer was the index layer, including the specific indexes required for the assessment of each criterion layer. The ecological vulnerability indexes included annual average temperature, annual average rainfall, slope, soil texture, soil pH, soil organic matter, soil type, vegetation coverage, land use type, net primary productivity, ecological space type, vegetation type, habitat quality index, and geological disasters. The accessibility to interference indexes included elevation, topographic relief, grade road density, grade water system density, population density, per capita GDP, residential area density, etc. The resource easy-attractiveness indexes included tourism resource density, mineral resource density, development intensity index, species resource density, livestock pressure, etc. In addition, the indexes contained in each criterion layer can be flexibly adjusted according to the data acquisition.

S2. Preprocessing was performed on the ecological disturbance risk identification and assessment indexes.

S21. Indexes were basically pretreated.

According to the spatial scope of the Qinling region, the assessment indexes were subject to spatial clipping, rasterizing, coordinate system conversion, resampling and other processing operations to ensure that the data range, format and spatial resolution of all indexes were consistent.

S22. Index normalization pretreatment was carried out.

S221. For qualitative indexes, the qualitative indexes were first quantified by expert grading assignment method, and then were normalized by range standardization. The qualitative indexes included soil type, soil pH, soil organic matter, land use type and ecological space type. The grading assignment results are shown in Table 2.

TABLE 2
Grading assignment results of qualitative indexes

| | Standardized assignment | | | | |
|---|---|---|---|---|---|
| Index | 1 | 2 | 3 | 4 | 5 |
| Land use | Other | Woodland | Grassland | Agricultural land | Residential |
| type | | | | | land |
| Ecological | National nature | Other national | Provincial | Ecological | Other |
| space type | reserve core | nature reserves | Nature Reserve | conservation | spaces |
| | area | | | redline area | |
| Soil pH | <6.0 | 6.0-6.5 | 6.5-7.5 | 7.5-8.5 | >8.5 |
| Soil type | Alfisol | Ferrallisols | Pedocal | hydromorphic soil | Primary soil |
| | Semi-Alfisols | Man-made | High-Mountain | semi-hydromorphic | saline-alkali |
| | | soil | Soil | soil | soil |
| Soil organic | >6 | 4-6 | 2-4 | 1-2 | <1 |

S222. For quantitative indexes, the range standardization method was adopted to make the range of each index range between 0-1. At the same time, due to the positive and negative relationship between assessment indexes and ecological disturbance risk, different range standardized calculation formulas should be used. The positive relationship was that the greater the assessment index value, the higher the ecological disturbance risk. The negative relationship was that the greater the assessment index value, the smaller the ecological disturbance risk.

S3. Ecological disturbance risk identification and assessment indexes were selected.

The linear regression model of each independent variable and other independent variables were constructed in turn, and the multicollinearity between the assessment indexes was judged according to the variance inflation factor. 10 was taken as the judgment boundary. When VIF<10, there was no multicollinearity. In this project, a total of n=26 indexes were used to construct the linear regression model. After multicollinearity judgement, p=14 indexes were selected to participate in the calculation of the ecological disturbance risk identification and assessment model. There were eight ecological vulnerability indexes, including slope, soil pH, soil type, soil organic matter, vegetation coverage, land use type, net primary productivity and ecological space type. There were three accessibility to interference indexes, including population density, grade road density and residential area density. There were three easy-attractiveness indexes, including tourism resource density, mineral resource density and species resource density.

S4. The ecological disturbance risk assessment model was determined.

According to the ecological disturbance risk identification and assessment function framework and the index selection result, the ecological disturbance risk identification and assessment model was constructed as follows:

RIED=W_{EV}·ecology vulnerability index
+W_{AI}·accessibility to interference index
+W_{RE}·resource easy−attractiveness index

Ecology vulnerability index=W_{α1}·slope+W_{α2}·soil pH+W_{α3}·soil type
+W_{α4}·soil organic matter
+W_{α5}·vegetation coverage
+W_{α6}·land use type
+W_{α7}·net primary productivity
+W_{α8}·ecological space type

Accessibility to interference index=W_{β1}·population density
+W_{β2}·grade road density
+W_{β3}·residential area density

Resource easy−attractiveness index=W_{γ1}·tourism resource density
+W_{γ2}·mineral resource density
+W_{γ3}·species resource density

Where, W_{EV}, W_{AI} and W_{RE} were weight values of ecology vulnerability index, accessibility to interference index and resource easy-attractiveness index respectively. W_{α1}, W_{α2}, W_{α3}, W_{α4}, W_{α5}, W_{α6}, W_{α7}, W_{α8} were weight values of slope, soil pH, soil type, soil organic matter, vegetation coverage, land use type, net primary productivity and ecological space type. W_{β1}, W_{β2} and W_{β3} were weight values of population density, grade road density and residential area density. W_{γ1}, W_{γ2} and W_{γ3} were weight values of tourism resource density, mineral resource density and species resource density.

S5. Weight parameters of ecological disturbance risk identification and assessment model were optimized.

Based on the minimization objective function and particle swarm optimization algorithm, the model weight assignment was optimized. VALUEₐ in the minimization objective function was the grid risk value of human disturbance activities in the general investigation data of geographical conditions. In this project, the grid size was 100 m×100 m. i, j and k were the number of indexes included in ecological vulnerability, accessibility to interference and resource easy-attractiveness, that is, i=8, j=3, k=3. The learning factors were initialized as c1=c2=2, the search space dimension D=p=14, the number of iterations Z=500, the particle population M=100, and the weight system w=0.731.

Combined with the ecological disturbance risk identification and assessment model and the index data, the ecological disturbance risk index weights based on particle swarm optimization algorithm was established and obtained in MATLAB R2018b. As shown in Table 3:

TABLE 3
Optimal weight optimization results of
risk index of ecological disturbance

| Target layer | Criterion layer | Index layer | Weight |
|---|---|---|---|
| RIED | Ecology vulnerability | Slope | 0.278 |
| | (0.413) | Soil pH | 0.053 |
| | | Soil type | 0.051 |
| | | Soil organic matter | 0.073 |
| | | Vegetation coverage | 0.097 |
| | | Land use type | 0.104 |
| | | Net primary productivity | 0.169 |
| | | Ecological space type | 0.174 |
| | Accessibility to | Population density | 0.327 |
| | interference | Grade road density | 0.413 |
| | (0.327) | Residential area density | 0.260 |
| | Resource | Tourism resource density | 0.142 |
| | easy-attractiveness | Mineral resource density | 0.573 |
| | (0.260) | Species resource density | 0.285 |

S6. Ecological disturbance risk identification and assessment results were output.

The index weight parameters optimized based on the particle swarm optimization algorithm were substituted into the ecological disturbance risk identification and assessment model for calculation, the result of the risk index of ecological disturbance was output, and the assessment results were graded and visually displayed. The ecological disturbance risk can be divided into five levels: lowest risk area, lower risk area, medium risk area, higher risk area and highest risk area. The thresholds of ecological disturbance risk level division in Qinling region are shown in Table 4.

TABLE 4
Thresholds of ecological disturbance
risk level division in Qinling region

| | Risk level | | | | |
|---|---|---|---|---|---|
| | Lowest | Lower | Medium | Higher | Highest |
| | risk | risk | risk | risk | risk |
| | (I) | (II) | (III) | (IV) | (V) |
| Range | 0.07-0.20 | 0.20-0.25 | 0.25-0.32 | 0.32-0.42 | 0.42-0.73 |

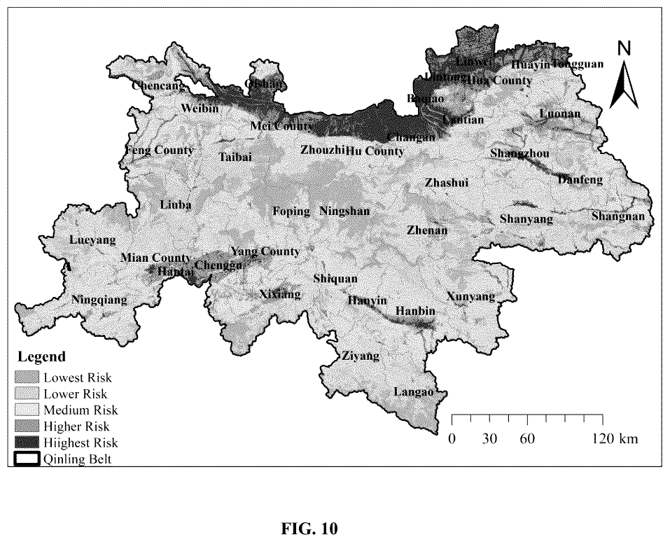

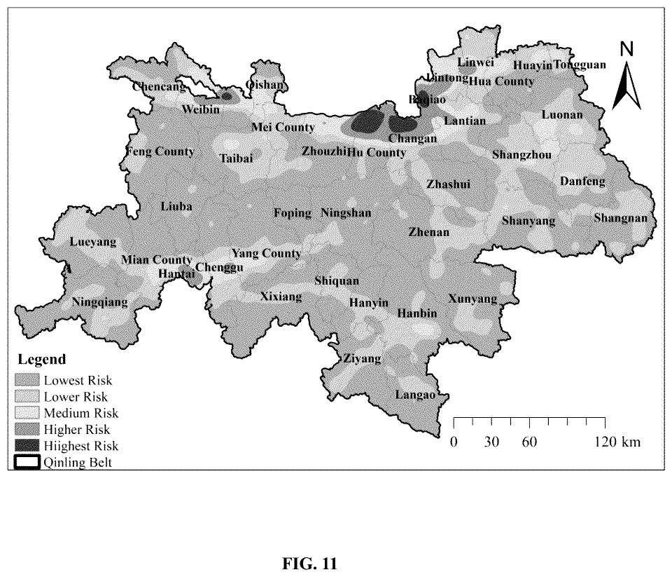

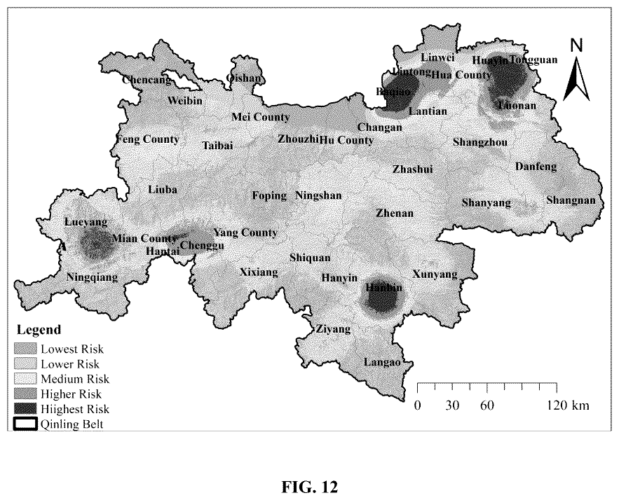

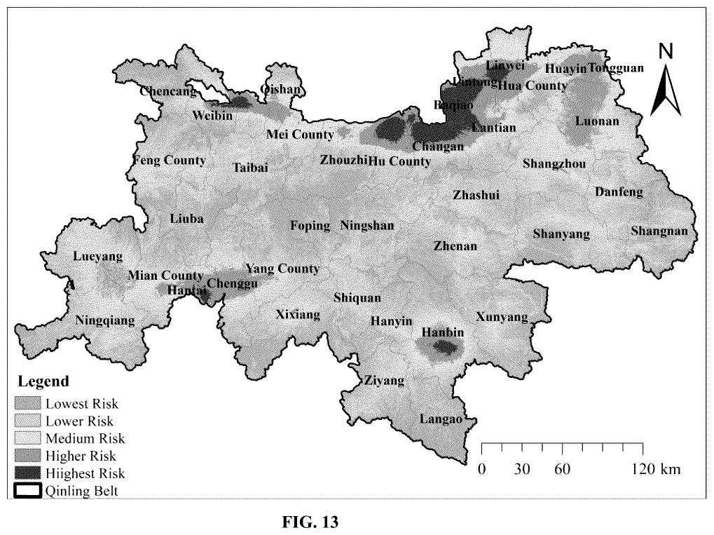

With the help of ArcGIS10.8 visual mapping software, ecological vulnerability index level map, accessibility to interference index level map, resource easy-attractiveness index level map and ecological disturbance risk level thematic map were drawn, as shown in FIG. 10 to FIG. 13.

Based on the above cases, it shows that the disclosure can realize the optimization of the index weight parameters of the ecological disturbance risk identification and assessment model and the optimization of the assessment indexes by introducing the particle swarm optimization algorithm and the VIF multicollinearity detection.

The above describes in detail the method for ecological disturbance risk identification and assessment based on automatic parameter adjusting optimization model provided by the disclosure. In the embodiments, specific examples are applied to explain the principle and implementation mode of the disclosure. The description of the above embodiments is only used to help understand the method and core idea of the disclosure. Meanwhile, for those skilled in the art, there will be changes in the specific implementation mode and application scope according to the idea of the disclosure. In conclusion, the contents of this specification shall not be construed as limiting the disclosure.

The above description of the disclosed embodiments enables the skilled in the art to achieve or use the disclosure. Multiple modifications to these embodiments will be apparent to those skilled in the art, and the general principles defined herein may be achieved in other embodiments without departing from the spirit or scope of the disclosure. The present disclosure will therefore not be restricted to these embodiments shown herein, but rather to comply with the broadest scope consistent with the principles and novel features disclosed herein.

What is claimed is:

1. A method for ecological disturbance risk identification and assessment based on automatic parameter adjusting optimization model, comprising
S1. establishing a three-layer ecological disturbance risk assessment index system based on an ecological disturbance risk identification and assessment function, wherein a target layer is a risk index of ecological disturbance, a criterion layer is a sub risk index of ecological disturbance, and an index layer is assessment indexes of each sub risk index of ecological disturbance; an assessment area is divided into grids, and the sub risk indexes of ecological disturbance are calculated with the grids as assessment units;
S2. performing normalization preprocessing on the assessment indexes;
S3. calculating a multicollinearity among the indexes in combination with a linear regression model of each assessment index based on variance inflation factor method, and screening the assessment indexes meeting a multicollinearity judgement interval;
S4. establishing an ecological disturbance risk assessment model according to the ecological disturbance risk assessment index system and the assessment indexes after normalization preprocessing and the multicollinearity judgement, wherein a model weight of the ecological disturbance risk assessment model comprises a criterion layer index weight and an index layer index weight;
S5. optimizing weight parameters of the ecological disturbance risk assessment model based on particle swarm optimization algorithm to obtain an optimal solution of the model weight, including:
S51. establishing a weight parameter optimization objective function:
$$min F = {\sum }_{a = 1}^{N} ( {RIED}_{a} - {VALUE}_{a} )$$
$${W}_{EV} + {W}_{AI} + {W}_{RE} = 1$$
$${W}_{α1} + {W}_{α2} + … + {W}_{α i} = 1$$
$${W}_{β1} + {W}_{β2} + … + {W}_{β j} = 1$$
$${W}_{γ1} + {W}_{γ 2} + … + {W}_{γ k} = 1$$
$$i + j + k = p$$
wherein, N is the total number of grids in the assessment area; RIEDₐ is an risk index of ecological disturbance of each grid calculated by the assessment model; VALUEₐ is a risk value of human disturbance activities for each grid; p is the total number of the assessment indexes involved in the calculation of ecological disturbance risk identification and assessment i, j and k are the number of the assessment indexes included in ecology vulnerability, accessibility to interference and resource easy-attractiveness respectively;
S52. calculating individual fitness of the assessment indexes according to the weight parameter optimization objective function;
S53. calculating individual extreme values and global extreme values of the assessment indexes by the particle swarm optimization algorithm, updating particles, calculating the individual fitness of S52 again, and executing S53 circularly until termination conditions are met; and
S54. outputting a swarm optimal value as a model weight optimal solution according to the weight parameter optimization objective function;
S6. substituting the optimal solution of the model weight into the ecological disturbance risk identification and assessment model for calculation, and outputting a result of the risk index of ecological disturbance.

2. The method for ecological disturbance risk identification and assessment based on automatic parameter adjusting optimization model of claim 1, wherein the ecological disturbance risk identification and assessment function is the function of the risk index of ecological disturbance PIED on the sub risk indexes of ecological disturbance, and the sub risk indexes of ecological disturbance comprise ecology vulnerability EV, accessibility to interference AI and resource easy-attractiveness RE.

3. (canceled)

4. The method for ecological disturbance risk identification and assessment based on automatic parameter adjusting optimization model of claim 1, wherein the S2 comprises:
S21. performing a preprocessing operation on the assessment area to make data range, format and spatial resolution of the assessment indexes consistent, wherein the preprocessing operation comprises: clipping, rasterizing, coordinate system conversion and resampling; and
S22. normalizing the assessment indexes by range standardization method.

5. The method for ecological disturbance risk identification and assessment based on automatic parameter adjusting optimization model of claim 4, wherein the S22 comprises: normalizing the quantitative assessment indexes by range standardization method; quantifying the qualitative assessment indexes first by expert grading assignment method, and then normalizing by range standardization method, so that the range of each assessment index is between 0 and 1.

6. The method for ecological disturbance risk identification and assessment based on automatic parameter adjusting optimization model of claim 1, wherein the linear regression model in S3 is that each independent variable of the assessment indexes is a linear regression function with respect to other independent variables of the assessment indexes.

7. The method for ecological disturbance risk identification and assessment based on automatic parameter adjusting optimization model of claim 1, wherein the calculating a multicollinearity VIFᵢ among the indexes and screening the assessment indexes meeting a multicollinearity judgement interval comprises:
$${VIF}_{i} = \frac{1}{1 - {R}_{i}^{2}}$$
$${R}_{i}^{2} = \frac{\sum {( {\hat{x}}_{i} - \overline{{x}_{i}} )}^{2}}{\sum {( {x}_{i} - \overline{{x}_{i}} )}^{2}}$$
wherein, \hat{x}ᵢ is a result of the i-th assessment index obtained by fitting the model, xᵢ is an actual result of the i-th index, and x̅ᵢ is an average of the actual results of the i-th index; and
screening the assessment indexes meeting VIFᵢ<S to participate in the calculation of the ecological disturbance risk identification and assessment model, wherein S is a multicollinearity judgement boundary.

8. The method for ecological disturbance risk identification and assessment based on automatic parameter adjusting optimization model of claim 1, wherein the ecological disturbance risk identification and assessment model is built as follows:
RIED=W_{EV}·A_{EV}+W_{AI}·A_{AI}+W_{RE}·A_{RE}
A_{EV}=W_{α1}·α1+W_{α2}·α2+ . . . +W_{αi}·αi
A_{AI}=W_{β1}·β1+W_{β2}·β2+ . . . +W_{βj}·βj
A_{RE}=W_{γ1}·γ1+W_{γ2}·γ2+ . . . +W_{γk}·γk
wherein, RIED is the risk index of ecological disturbance , with a range of [0,1] to indicate a possibility and damage degree of the regional ecosystem affected by natural factors or human activities; A_{EV}, A_{AI} and A_{RE} are ecology vulnerability index, accessibility to interference index and resource easy-attractiveness index respectively; αi is standard values after the normalized pretreatment included in ecological vulnerability; βj is standard values after the normalized pretreatment included in accessibility to interference; γk is standard values after the normalized pretreatment included in resource easy-attractiveness.

9. (canceled)

10. The method for ecological disturbance risk identification and assessment based on automatic parameter adjusting optimization model of claim 1, wherein the S6 comprises: grading, mapping and displaying visually the assessment results of the risk index of ecological disturbance, and/or grading, mapping and displaying visually the assessment results of each sub risk index of ecological disturbance.
